(19) United States
(12) Patent Application Publication
(10) Pub. No.: US 2026/0016354 A1
(43) Pub. Date: Jan. 15, 2026

(54) BOLT AXIAL FORCE MONITORING APPARATUS AND MONITORING METHOD

(71) Applicant: IKEDA METAL INDUSTRIAL CO., LTD., Osaka (JP)

(72) Inventor: Hiroki TAKEI, Osaka (JP)

(73) Assignee: IKEDA METAL INDUSTRIAL CO., LTD., Osaka (JP)

(21) Appl. No.: 19/267,901

(22) Filed: Jul. 14, 2025

(30) Foreign Application Priority Data
Jul. 12, 2024 (JP) 2024-112453

(51) Int. Cl. G01L 5/24; G06T 11/00

(52) U.S. Cl. CPC G01L 5/24; G06T 11/001

(57) ABSTRACT

A bolt axial force monitoring system is disclosed, enabling detection of bolt loosening from a remote location using a simple structure. The system includes a bolt 1 with a display 2 that changes color based on axial force variation. A sensor (e.g., RGB sensor 4) detects this color change. A first communication unit 51 transmits the sensor data, supported by a power supply. At a remote site, a second communication unit 52 receives the data. A determination unit 10 evaluates the change in axial force from the received data, and an output unit such as a display 11 and storage 12 outputs the evaluated information.

### CROSS-REFERENCE TO RELATED APPLICATION

This application is based upon and claims the benefit of priority from Japan Patent Application No. 2024-112453, filed on Jul. 12, 2024, the entire contents of which are incorporated herein by reference.

### FIELD OF INVENTION

The present disclosure relates to a bolt axial force monitoring apparatus and monitoring method capable of detecting loose bolts at a location distant from a fastening point of the bolts.

### BACKGROUND

In recent years, inspection of a fastening condition of bolts is becoming important in terms of long-term maintenance of equipment. Conventionally, the bolt is fastened by torque input at a predefined value using a torque wrench, etc. However, axial force of a screw that is essentially required is very unstable due to friction of the screw and friction of a seat surface, and different axial force is applied to each of the bolts.

As a measurement method of the axial force, for example, those shown in Patent Documents 1 and 2 utilizing strain gauges (including load cells) are used for case-by-case measurement such as basic conditioning and basic research. Furthermore, in the ultrasonic type shown in Patent Document 3, a specially-processed bolt is prepared such as by parallel-grinding an upper portion and lower portion of the screw, mounting a sensor to a head of the bolt, and the axial force is detected from a response of ultrasonic waves. The ultrasonic type is generally only for the measurement, and for example, can only be used initial and annual inspection of fastening of flange structures that receive external force and cannot be used for bus bars and the like where electricity is generated due to electrical noise, etc.

### SUMMARY OF INVENTION

### Problems to be Solved by Invention

These apparatuses described in the conventional technologies all have many electronic components attached to the bolt and complicated structures. These types of monitoring apparatuses should be installed at fastening points where loose bolts may cause a major accident or high points and narrow points where maintenance is difficult to periodically monitor the axial force of the bolts and find their loosening. Therefore, it is desirable for these types of monitoring apparatuses to have a simple structure, high detection accuracy, and low power consumption required to detect the axial force and transmit data to a monitoring location distant from the fastening points of the bolts.

To address the above problems, the objective of the present disclosure is to provide a bolt axial force monitoring apparatus and monitoring method capable of detecting loose bolts at a location distant from a fastening point of the bolts.

### Means to Solve the Problem

A bolt axial force monitoring apparatus of the present disclosure includes the following structures.
(1) a bolt that indicates a change in axial force of the fastened bolt as a change in color on a display provided on a part of the bolt.
(2) a sensor that detects the change in the color indicated on the display of the bolt.
(3) a first communication unit that transmits data of the change in the axial force detected by the sensor to a location distant from a fastening point of the bolt.
(4) a power supply for the sensor and the communication unit.
(5) a second communication unit that is provided at the location distant from the fastening point of the bolt and receives the data of the change in the axial force from the first communication unit.
(6) a determination unit that determines the change in the axial force of the bolt based on the data of the change in the axial force received by the second communication unit.
(7) an output unit that outputs information of the change in the axial force of the bolt determined by the determination unit.

A bolt axial force monitoring apparatus of the present disclosure may include the following configuration.
(1) the sensor includes an RGB sensor.
(2) the sensor, the communication unit, and the power supply are housed in one housing, and the housing is fixed to the bolt and/or the fastening points of the bolt so as to cover a head of the bolt.
(3) the bolt axial force monitoring apparatus includes a timer that controls operation of the sensor, and activates the sensor only when monitoring the axial force and transmits the data of the change in the axial force.
(4) a plurality of the bolts is provided to the fastening points, the sensor, the first communication unit, and the power supply are provided to each of the plurality of the bolts, and the determination unit compares a pattern of the data of the change in the axial force received from the plurality of the bolts and a pattern of the data of the change in the axial force of the plurality of the bolts stored in a storage in advance and determines whether the fastening position is fastened by the plurality of the bolts or not.
(5) the sensor is a camera that images the color indicated on the display of the bolt.

A bolt axial force monitoring method of the present disclosure includes the following steps.
(1) a step of mounting a sensor that detects a change in color indicated on a display of a bolt that indicates a change in axial force of the fastened bolt as a change in color on a display provided on a part of the bolt.
(2) a step of transmitting data of the change in the axial force detected by the sensor to a location distant from a fastening point of the bolt.
(3) a step of receiving the data of the change in the axial force at the location distant from the fastening point of the bolt.
(4) a step of determining the change in axial force of the bolt based on the received data of the change in the axial force.
(5) a step of outputting information of the change in the axial force of the bolt determined in the determining step.

### Effect of Invention

The present disclosure can detect loose bolts at a location distant from a fastening point of the bolts.

### BRIEF DESCRIPTION OF DRAWINGS

FIG. 1 is a cross-sectional view illustrating an example of the bolt in the first embodiment.

FIG. 2 is a functional block diagram showing a detection unit provided in the first embodiment.

FIG. 3 is a schematic cross-sectional view showing the structure of the detection unit of the first embodiment.

FIG. 4 is a block diagram illustrating the entire configuration of the bolt axial force monitoring apparatus of the first embodiment.

FIG. 5 is a block diagram illustrating the bolt axial force monitoring apparatus of the second embodiment.

FIG. 6 is a block diagram illustrating the bolt axial force monitoring apparatus of the third embodiment.

FIG. 7 is a cross-sectional view showing another embodiment of the detection unit of the present disclosure.

FIG. 8 is a cross-sectional view illustrating yet another embodiment of the detection unit of the present disclosure.

### EMBODIMENTS

### 1. First Embodiment

### 1-1. Configuration of First Embodiment

### 1-1-1. Mounting Portion to Bolt

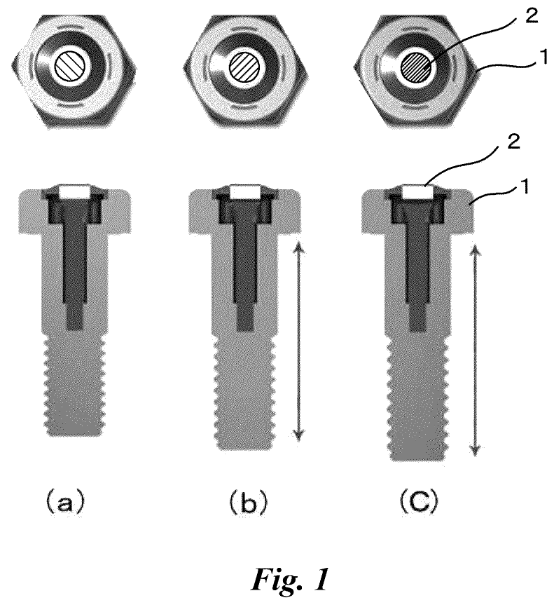

As illustrated in FIG. 1, a bolt axial force monitoring apparatus used in the present embodiment indicates a change in axial force of the fastened bolt 1 that is the monitoring target as a change in color on a window-type display 2 provided in a part of the bolt 1. One example of this bolt 1 is a known bolt 1 called DTI system (trademark) or SmartBolts (trademark) provided by the applicant that changes color due to a change in axial force.

As illustrated in FIG. 1, in this bolt 1, color indicated on a display 2 changes according to the axial force of the bolt 1 by utilizing an indicator embedded therein. In detail, as the axial force changes, the color changes from red in FIG. 1(a) where the axial force is zero to black in FIG. 1(c) where appropriate axial force is achieved as the axial force becomes larger, so that the tightening condition can be visually observed. By this, the loosening and over-tightening of the bolt 1 can be easily determined, contributing to more efficient maintenance and safety improvement.

The bolt 1 of the present disclosure is not limited to SmartBolts (trademark) provided by the applicant, and other bolt 1 may be used if the bolt 1 has the display 2 that changes color according to the axial force. For example, the bolts 1 described in US Patent U.S. Pat. No. 3,987,699A, US490,413A, US795,814A, and US Publication US2009/0092457A may be used.

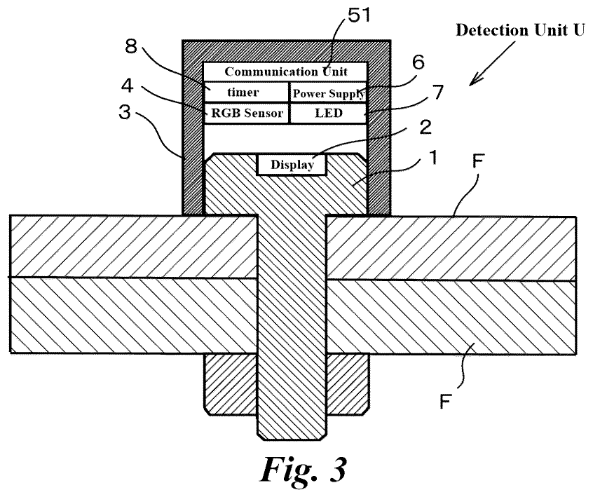

As illustrated in FIG. 3, in the bolt axial force monitoring apparatus of the present embodiment, a detection unit U is detachably provided to the head of the bolt 1 to detect a change in the color of the display portion 2 of the bolt 1, as shown in FIG. 1. The detection unit U includes a waterproof housing 3, and various components according to the present embodiment are housed within the housing 3. The housing 3 may include multiple attachment means to allow the detection unit U to be easily and securely attached to the head of the bolt 1. For example, the housing may include a fitting formed to match the shape of the bolt head, a strong magnet such as a neodymium magnet, or a fixing structure using a screw provided at the bottom of the housing 3. Furthermore, depending on the structure of the installation location, a flange may be formed at the bottom of the housing 3, and the housing 3 can be fixed so as to cover the head of the bolt 1 by screwing the flange to a surface of the structure F.

With such a configuration, the detection unit U can be stably mounted even under constraints related to the size or shape of the bolt 1, the installation location, or in environments subjected to vibration or shock. In addition, since the detection unit U is detachable, it facilitates on-site maintenance, inspection, and replacement work, thereby contributing to improved work efficiency and prolonged service life of the apparatus. Moreover, because the housing 3 is structured to cover the head of the bolt 1, it can prevent direct sunlight and dust from reaching the display portion 2, thereby ensuring the visibility of the display portion 2 and enhancing the stability of detection accuracy. If necessary, the material and shape of the housing 3 may be selected or processed according to the on-site environment (e.g., indoor/outdoor, humidity, temperature), allowing it to be designed to meet required performance such as light shielding, waterproofness, dustproofness, and heat resistance.

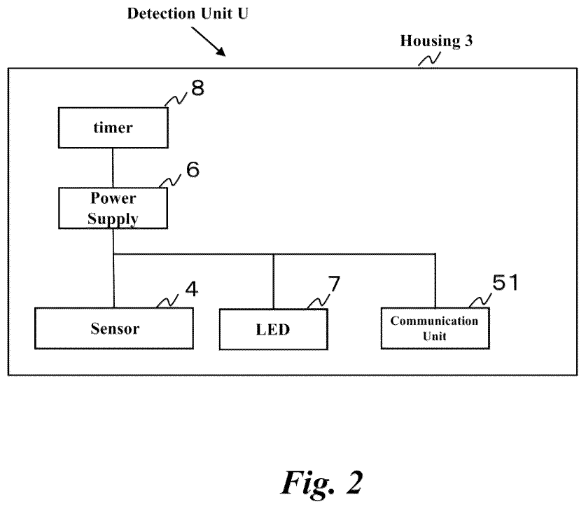

As illustrated in FIGS. 2 and 3, inside the housing 3 of the detection unit U, a sensor that detects the change in color indicated on the display 2 of the bolt 1, a first communication unit 51 that transmits data of the change in axial force detected by the sensor to a location distant from the fastening point, and a power supply 6 for the sensor and the first communication unit 51 are provided. Furthermore, when the change in color cannot be checked only by natural light, such as when material of the housing 3 is opaque, when the bolt 1 that is the monitoring target is installed indoors, and when the monitoring is required at night, it is preferable to provide an LED 7 as a light emitting unit to check the color on the display 2 inside the housing 3.

In the present embodiment, an RGB sensor 4 is used as the sensor. The RGB sensor 4 detects the three basic colors of red, green, and blue, and identifies the color of objects. The RGB sensor 4 measures the intensity of the basic colors and combines the basic colors to reproduce a broad range of colors. Typically, light is irradiated to the display 2 of the bolt 1 using the LED 7, and the reflected light is detected by the RGB sensor 4. By this, the RGB sensor can recognize the color indicated on the display 2.

The following sensors may be used as the sensor other than the RGB sensor, however, the RGB sensor is preferable in particular when monitoring the bolt 1 with a small diameter or large number of bolts because it has simple configuration and can be easily downsized.

### (1) CMOS Sensor

A CMOS (Complementary Metal-Oxide-Semiconductor) sensor detects colors by placing a RGB filter on each pixel.

### (2) CCD Sensor

A CCD (Charge Coupled Device) sensor detects colors by using an RGB filter and has high sensitivity and low noise.

### (3) Spectral Sensor

A spectral sensor detects light of multiple wavelengths to obtain more detailed color information.

### (4) Photodiode Array

A plurality of photodiode array is arranged and detects colors by attaching different color filters on each of the photodiode arrays.

Short range wireless communication technologies such as Bluetooth (trademark) can be used as the first communication unit 51 and a second communication unit 52. Bluetooth is suitable for battery operation due to low power consumption, and in particular, Bluetooth Low Energy is very power efficient. Furthermore, since Bluetooth has the communication range of about 10 meters to 100 meters and can be connected to a plurality of devices at the same time, it is suitable when monitoring a plurality of the bolts 1 at the same time. Furthermore, since Bluetooth has data encryption, device authentication function, and high security, it is suitable for installing the second communication unit 52, the determination unit 10, and the storage 12 and the like that are provided outside the fastening point in various devices such as smartphones tablets, PCs, and smartwatches, etc.

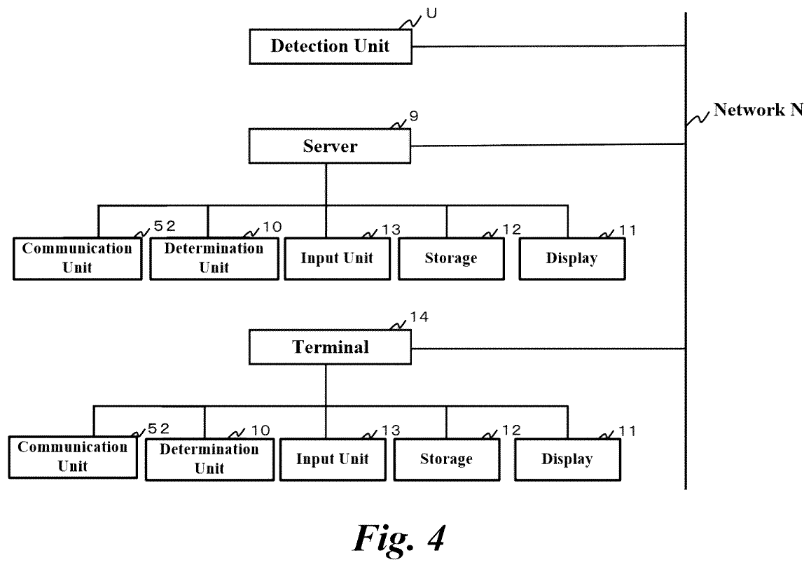

The first communication unit 51 may be other power saving wireless communication and wired communication utilizing signal lines as described below. Note that, although FIGS. 4 to 6 indicates signal lines to clearly indicate the connection relationship between the first communication unit 51 and the second communication unit 52, the present disclosure is not limited to wired communication.
(1) 2.4 GHz RF (Radio Frequency)
(2) WiFi (2.4 GHz or 5 GHz)
(3) Zigbee (Trademark)
(4) Z-Wave (Trademark)
(5) LoRa (Long Range) (Trademark)
(6) ANT+ (Trademark)
(7) NFC (Near Field Communication) (Trademark)

In the present embodiment, button batteries, dry cell batteries, and lithium-ion batteries installed inside the housing 3, or rechargeable batteries such as solar power generation panels may be used as the power supply 6 for the sensor, the LED 7 and the first communication unit 51. Note that, in the case of wired communication, power supply lines may be used together with the signal lines instead of batteries.

A timer 8 that controls the operation of the RGB sensor 4 is provided inside the housing 3. This timer 8 turns on the power supply 6 for the RGB sensor 4, the LED 7, and the communication unit 5 only when monitoring the axial force. That is, since the power consumption of the timer 8 alone is significantly smaller than other devices, by turning on the power supply 6 for each device at regular intervals set in the timer 8, the axial force of the bolt 1 can be monitored periodically for a long time with small power consumption.

1-1-2. Location Distant from Fastening Point

As illustrated in FIG. 4, a server 9 to monitor the change in axial force of the bolt 1 is provided at the location distant from the fastening point of the bolt 1. This server 9 includes the second communication unit 52 that receives data of the change in axial force from the first communication unit 51 provided inside the housing 3 at the bolt-1 side, a determination unit 10 that determines the change in axial force of the bolt 1 based on the data of the change in axial force received by the second communication unit 52, and an output unit that outputs information of the change in axial force of the bolt 1 determined by the determination unit 10. Note that the determination unit 10 determines the change in axial force from the received change data itself or by performing predetermined calculation on the change data.

If necessary, the server 9 includes an input unit 13 such as keyboards and touch panels that receive instruction from a user. When providing an interface for the user only to a terminal 14 described later, the server may only include the second communication unit 52 and the determination unit 10.

The second communication unit 52 receives the data from the first communication unit 51 provided inside the housing 3 and has functions corresponding to types of the first communication unit 51. The determination unit 10 detects data related to the change in color, for example the change from black indicating appropriate fastening strength to red indicating loosening, indicated on the display 2 detected by the RGB sensor 4, and determines that the bolt 1 that is the monitoring target is loose. The output unit is a storage 12, a display 11, and the like that stores the determination result.

The server 9 is connected to the terminal 14, such as PCs and tablets, via a network N. The display means such as the display 11 and printers, the storage 12 that stores the determination result, and the output unit for the determination result such as alert devices are provided to the terminal 14 depending on the monitoring content required by the user.

The data from the first communication unit 51 may be directly transmitted to the terminal 14 such as PCs and tablets instead of the server 9 connected to the network N, in this case, the second communication unit 52, the determination unit 10, and the output unit are provided to the terminal 14.

### 1-2. Action of First Embodiment

In the present embodiment, in the case the bolt is fastened to a structure F, when the bolt 1 is fastened by appropriate axial force, the display indicates a color (for example, black) indicating the appropriate axial force according to the axial force applied to the bolt.

To monitor the axial force of the bolt 1 fastened to the structure F, the housing containing the sensor and others is mounted to the head of the fastened bolt 1. Since the monitoring apparatus of the present embodiment includes the timer 8, when the predefined monitoring time comes, the timer 8 turns on the power supply for the devices such as the RGB sensor 4, the LED 7, the first communication unit 51, and others inside the housing 3. Then, the LED 7 irradiates light to the display 2, the reflected light reaches the RGB sensor 4, and the RGB sensor 4 detects the color indicated on the display 2.

The data related to the color detected by the RGB sensor 4 is transmitted to the server 9 via the first communication unit 51 and the network N, and the determination unit in the server 9 determines whether the color indicates that the normal axial force is applied on the bolt 1 (for example, black) or that the axial force is reduced and the fastening torque of the bolt 1 is insufficient (for example, red). The determination unit 10 outputs the determination result on the output unit such as the display 11 and the storage 12 provided thereto and transmits the determination result to the terminal 14 connected to the server 9 via the network N. Note that, when the determination unit 10 is only provided in the server 9, the determination result is not output on the server 9 itself and is only transmitted to the terminal 14.

The terminal 14 that has received the determination result outputs the determination result on the output unit such as the display 11 and the storage 12 provided thereto, and the user can know if the bolt 1 that is the monitoring target is fastened by the appropriate axial force or not by reading the determination result.

### 1-3. Effect of First Embodiment

The effect of the monitoring apparatus of the present embodiment is as follows.
(1) By using the bolt 1 that indicates the change in axial force with color and detecting the change in said color with the RGB sensor 4, the loose bolt 1 can be accurately and easily detected compared to the conventional technology using ultrasonic sensors, etc.
(2) Since the detection result by the RGB sensor 4 is transmitted to the server 9 and the terminal 14 installed at the location distant from the fastening point of the bolt 1 by wired or wireless communication, it is not necessary for the user to go to the fastening point of the bolt 1 and inspect the axial force of each bolt 1. Therefore, the bolt 1 installed at high points and narrow points can be easily monitored.
(3) Since each component such as the RGB sensor 4 that detects the change in color, the LED 7, and the power supply 6 are housed in one housing 3, the change in color of the bolt 1 that is the monitoring target can be detected only by mounting the housing to the head of the bolt 1. Therefore, the installation of the monitoring equipment to the bolt 1 can be significantly easier than the conventional technology. Furthermore, by fixing the housing 3 to the head of the bolt 1 or the fastening point such as by screwing, the housing 3 will not be removed from the bolt 1.
(4) by covering the head of the bolt 1 with the housing 3, corrosion and heat resistance (thermal change prevention) effect can be obtained, while preventing disturbance such as sunlight when detecting the change in color of the display 2 using a light source such as the LED 7.
(5) By providing the timer 8 in the housing 3, the activation of the RGB sensor 4 that detects the change, and the LED 7 can be controlled by the timer 8, so that extremely low power consumption can be achieved by activating each component only at the time of measurement, allowing to continue the monitoring for a long time where the bolt 1 may loosen.

### 2. Second Embodiment

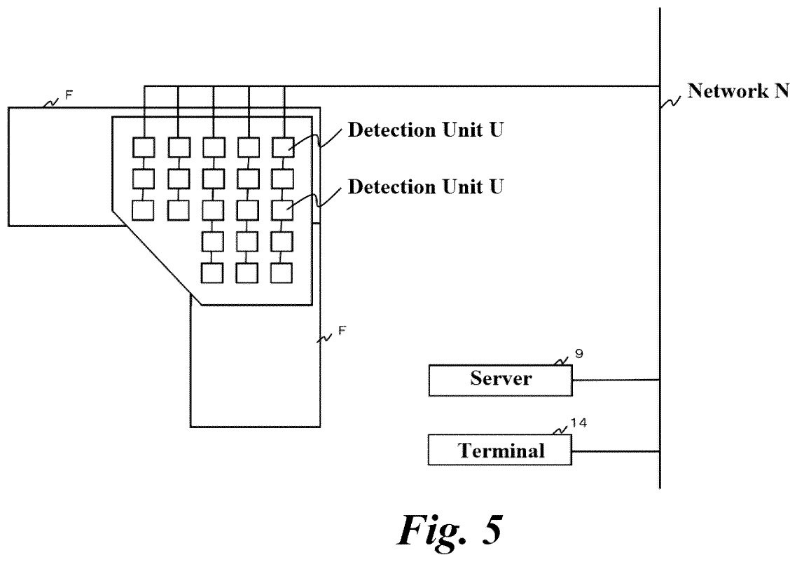

FIG. 5 illustrates the second embodiment of the present disclosure. In the second embodiment, when a plurality of the bolt 1 is installed at the fastening point of a certain range, a detection unit U including the sensor is installed in each of the plurality of the bolt 1.

Generally, in piers, frames of wind power generation equipment, and other buildings, a large structure F is fastened by a number of the bolts 1, and these bolts do not loosen at the same time. Furthermore, the criteria by which the reduction in the fixation strength between the structure F is considered out of the allowable range is different depending on the position and number of the loose bolts 1 among the plurality of the bolts 1. Therefore, in the second embodiment, the detection unit U in which each component such as the sensor is housed is attached to each of the plurality of the bolts 1, and the data of the change in color is transmitted from the plurality of the bolts 1 to the determination unit 10 of the server 9 and the terminal 14.

Meanwhile, a storage 12 that stores data that is the determination criteria is provided to the server 9 and the terminal 14, and data related to the position and the required axial force for each bolt 1 at the fastening point of the structure F, and a pattern of the loose bolt 1 that is the criteria to output an alarm are stored in the storage 12 in advance.

In the second embodiment, the determination unit 10 not only detects each loose bolt 1, but also compares a pattern of the data of the change in axial force received from the plurality of the bolts 1 and a pattern of the data of the change in the axial force of the plurality of the bolts 1 stored in the storage 12 in advance and determines whether the plurality of the bolts 1 at the fastening point is fastened or not. As a result, the user can monitor the condition of each bolt 1 provided at the fastening point and the joint strength of the entire structure F, allowing to easily and accurately perform the maintenance of the structure F.

In particular, in the present embodiment, by assigning a unique ID to the detection unit U mounted on each of the bolts 1, the detailed positional information of said loose bolt 1 can be indicated on the display. Furthermore, when the loose bolt is detected, said bolt 1 can be easily found in the actual installation location by illuminating light from the LED provided in the detection unit U. Accordingly, in the present embodiment, when the present embodiment is applied to the bolts, workers can easily find where the detected “loose bolts” are in the fastening site of the bolt 1.

### 3. Third Embodiment

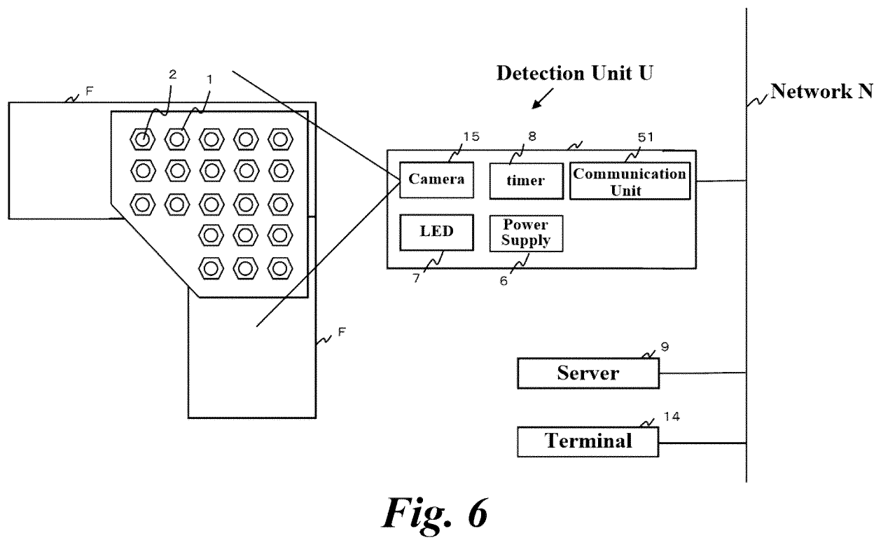

The third embodiment illustrated in FIG. 6 uses a camera for the sensor provided in the detection unit U. The camera can detect the change in color of the display 2 of one bolt 1 like the RGB sensor 4 in the first embodiment, and in the third embodiment, the camera is arranged at a position where the plurality of the bolt 1 can be imaged at the same time so that one camera can image the change in color indicated in the plurality of the bolt 1 at the same time.

Like the second embodiment, the determination unit 10 of the third embodiment compares a pattern of the data of the change in axial force received from the plurality of the bolts 1 and a pattern of the data of the change in the axial force of the plurality of the bolts 1 stored in the storage 12 in advance and determines whether the plurality of the bolts 1 at the fastening point is fastened or not.

In the third embodiment having such a configuration, since the plurality of the bolt 1 can be monitored by one camera without mounting the detection unit U to each bolt 1, it is advantageous in that the monitoring apparatus can be easily installed. Furthermore, like the second embodiment, by considering the change in color of the plurality of the bolt 1 as a pattern, the user can monitor the joint strength of the entire structure F, allowing to easily and accurately perform the maintenance of the structure F.

### 4. Other Embodiment

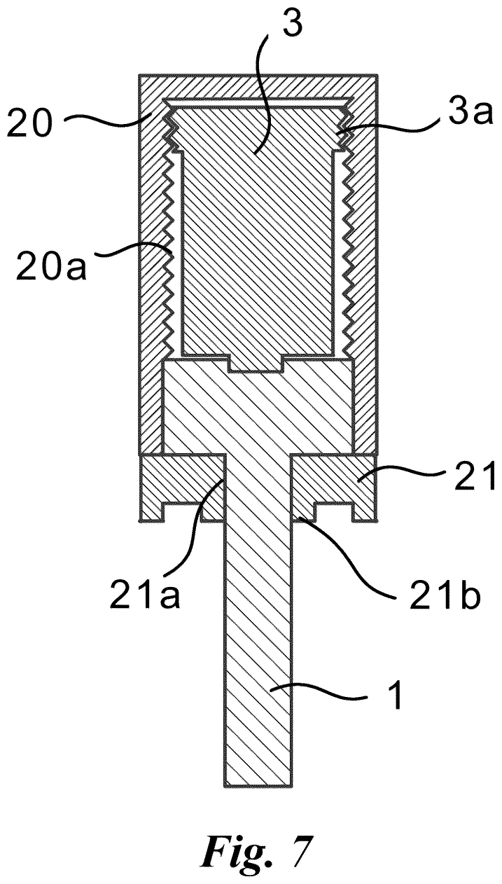

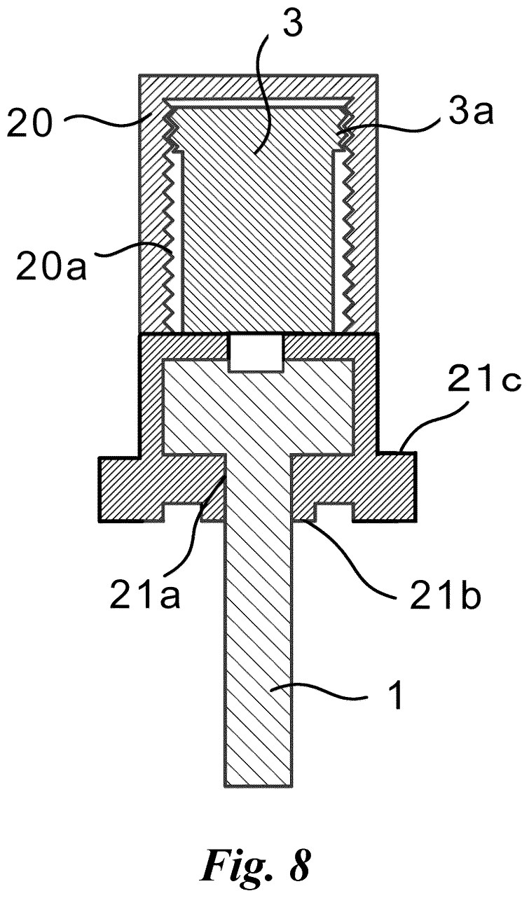

The present disclosure is not limited to the above embodiments and can be modified and implemented in the implementation stage without departing from the scope of the invention. Furthermore, various inventions may be produced by appropriately combining a plurality of the components disclosed in the above embodiments. For example, some components may be omitted from the entire components indicated in the embodiments. Furthermore, the following embodiments are included in the present disclosure.
(1) Other than the RGB sensor and the camera indicated in the embodiments, various sensors may be used for the sensor if the change in color can be detected. For example, color sensors based on the L*a*b* color system or the XYZ color system may be used.
(2) Like the second and third embodiments, when monitoring the plurality of the bolts at the same time, the alarm content to the user and the strength may be different in accordance with the number, position, and pattern of the bolt which changed the color. For example, the alarm may be issued only by one bolt, or when a change in a specific pattern occurs.
(3) When detecting the axial force of the plurality of the bolts, a plurality of the sensors that detect the change in color of the bolt may be installed in one housing. When the position and spacing of the plurality of the bolts are known in advance, the configuration can be simplified by using a common housing, power supply, and LED for the plurality of the bolts.
(4) When natural light or light from the surrounding can be irradiated to the display 2 of the bolt 1 by using a transparent housing or by providing windows for lighting, the lighting means such as LED may not be provided.
(5) As a configuration for fixing the detection unit to the bolt, the configuration illustrated in FIG. 7 may be adopted. That is, in FIG. 7, the housing 3 of the detection unit is formed of a cylindrical member, and the components constituting the detection unit, as illustrated in FIG. 2, are sealed inside. A male thread 3a is provided on an upper outer periphery of the housing 3. A weather-resistant protective cap 20 is mounted on an outer periphery of the housing 3. A female thread 20a is provided on an inner periphery of the protective cap 20, and by inserting the housing 3 into the protective cap 20 and rotating it, the male thread 3a and the female thread 20a are threaded together, thereby fixing the housing 3 inside the protective cap 20.
The lower portion of the protective cap 20 extends below the lower end of the housing 3, and a space is formed inside the lower portion of the protective cap 20 to accommodate the head of the bolt 1. The lower edge of the protective cap 20 is positioned on the same plane as the lower surface of the head of the bolt 1.
A seal cap 21 made of a material such as rubber or a flexible plastic is provided between the lower edge of the protective cap 20 and the lower surface of the head of the bolt 1. The seal cap 21 includes a bolt insertion hole 21a at its center, and the shaft of the bolt 1, which protrudes from the center of the protective cap 20, is inserted into this insertion hole 21a. The seal cap 21 closes the gap between the protective cap 20 and the head of the bolt 1. The seal cap 21 also functions to seal the gap between the structural member F fastened by the bolt 1 and the bolt 1, and the gap between the structural member F and the protective cap 20.
A female thread may be provided on the inner periphery of the insertion hole 21a of the seal cap 21. In that case, by screwing the seal cap 21 onto the shaft of the bolt 1, the seal cap 21 can be brought into close contact with both the lower edge of the protective cap 20 and the lower surface of the head of the bolt 1. Furthermore, a nut portion 21b may be integrally formed on the surface of the seal cap 21 opposite to the head of the bolt 1 so that the seal cap 21 can be easily rotated using a wrench.
Note that the insertion hole 21a may be a simple through-hole without a female thread. In such a case, by setting the inner diameter of the insertion hole 21a to be equal to or slightly smaller than the diameter of the shaft of the bolt 1, the shaft of the bolt 1 can be press-fitted into the insertion hole 21a while maintaining airtightness. Preferably, the seal cap 21 and the protective cap 20 are fixed together using an adhesive. This ensures a reliable fixation between the seal cap 21 and the protective cap 20, and improves the sealing performance between them.
   (6) As another example of the shape of the seal cap 21, the configuration illustrated in FIG. 8 may also be employed. In this configuration, the seal cap 21 partially covers the head of the bolt 1 and entirely encloses it. A flange 21c is provided at the lower portion of the seal cap 21. For example, by using a flexible material such as rubber for the flange 21c, the gap between the bolt 1 and the structure F can be filled and sealed.

### REFERENCE SIGN

1: bolt
2: display
3: housing
3a: male thread
4: RGB sensor
51: first communication unit
52: second communication unit
6: power supply
7: LED
8: timer
9: server
10: determination unit
11: display
12: storage
13: input unit
14: terminal
15: camera
20: protective cap
20a: female thread
21: seal cap
21a: insertion hole
21b: nut portion
21c: flange
U: detection unit
N: network
F: structure

1. A bolt axial force monitoring apparatus comprising:
a bolt that indicates a change in axial force of the fastened bolt as a change in color on a display provided on a part of the bolt;
a sensor that detects the change in the color indicated on the display of the bolt;
a first communication unit that transmits data of the change in the axial force detected by the sensor to a location distant from a fastening point of the bolt;
a power supply for the sensor and the first communication unit;
a second communication unit that is provided at the location distant from the fastening point of the bolt and receives the data of the change in the axial force from the first communication unit;
a determination unit that determines the change in the axial force of the bolt based on the data of the change in the axial force received by the second communication unit; and
an output unit that outputs information of the change in the axial force of the bolt determined by the determination unit.

2. The bolt axial force monitoring apparatus according to claim 1, wherein the sensor includes an RGB sensor.

3. The bolt axial force monitoring apparatus according to claim 2, wherein:
the sensor, the communication unit, and the power supply are housed in one housing, and
the housing is fixed to the bolt and/or the fastening points of the bolt so as to cover a head of the bolt.

4. The bolt axial force monitoring apparatus according to claim 3, comprising a timer that controls operation of the sensor,
wherein the bolt axial force monitoring apparatus activates the sensor only when monitoring the axial force and transmits the data of the change in the axial force.

5. The bolt axial force monitoring apparatus according to claim 1, wherein:
a plurality of the bolts is provided to the fastening points,
the sensor, the first communication unit, and the power supply are provided to each of the plurality of the bolts, and
the determination unit compares a pattern of the data of the change in the axial force received from the plurality of the bolts and a pattern of the data of the change in the axial force of the plurality of the bolts stored in a storage in advance, and determines whether the fastening position is fastened by the plurality of the bolts or not.

6. The bolt axial force monitoring apparatus according to claim 1, wherein the sensor is a camera that images the color indicated on the display of the bolt.

7. The bolt axial force monitoring apparatus according to claim 5, wherein the sensor is a camera that images the color indicated on the display of the bolt.

8. A bolt axial force monitoring method of the present disclosure, comprising:
a step of mounting a sensor that detects a change in color indicated on a display of a bolt that indicates a change in axial force of the fastened bolt as the change in the color on a display provided on a part of the bolt;
a step of transmitting data of the change in the axial force detected by the sensor to a location distant from a fastening point of the bolt;
a step of receiving the data of the change in the axial force at the location distant from the fastening point of the bolt;
a step of determining the change in the axial force of the bolt based on the received data of the change in the axial force;
a step of outputting information of the change in the axial force of the bolt determined in the determining step.

9. The bolt axial force monitoring apparatus according to claim 1, comprising:
a housing configured to accommodate the sensor unit and the first communication unit;
a protective cap configured to cover the housing and a head of the bolt; and
a seal cap configured to enclose the head of the bolt and the protective cap, the seal cap having an insertion hole for a shaft portion of the bolt.
